(19) United States
(12) Patent Application Publication
(10) Pub. No.: US 2013/0061298 A1
(43) Pub. Date: Mar. 7, 2013

(54) AUTHENTICATING SESSION PASSWORDS

(71) Applicants: Giuseppe Longobardi, C/mare di Stabia (IT); Maria E. Massino, Rome (IT); Marco Mattia, Rome (IT); Maria Sbriccoli, Rome (IT); Francesca Solida, Rome (IT)

(72) Inventors: Giuseppe Longobardi, C/mare di Stabia (IT); Maria E. Massino, Rome (IT); Marco Mattia, Rome (IT); Maria Sbriccoli, Rome (IT); Francesca Solida, Rome (IT)

(73) Assignee: International Business Machines Corporation, Armonk, NY (US)

(21) Appl. No.: 13/223,760

(22) Filed: Sep. 1, 2011

(51) Int. Cl. G06F 21/00

(52) U.S. Cl. 726/6

(57) ABSTRACT

A method for authenticating a password is provided. An authentication server device receives a plurality of password segments associated with a password from a client device over a plurality of communication channels. The authentication server device reconstructs the password from the plurality of password segments based on a particular set of parameters identified by a selected session key identification number. The authentication server device sends the reconstructed password to a target device for comparison with a stored password associated with the client device. If the stored password matches the reconstructed password, then the target device establishes a session with the client device so that the client device may access a resource located on the target device. In addition, the authentication server device closes the plurality of communication channels established with the client device in response to the authentication server receiving a notification that the reconstructed password matches the stored password.

### BACKGROUND

1. Field

The disclosure relates to a computer implemented method, data processing system, and computer program product for authenticating a network security password that has been segmented into a predetermined number of password segments and sent over a predetermined number of communication channels in parallel at a same time.

2. Description of the Related Art

Network security is becoming more and more important as businesses, governmental agencies, educational institutions, and individual users spend more and more time connected online. Compromising network security is often easier than compromising physical or local security, and is much more common today. Network security consists of provisions and policies designed to prevent and monitor unauthorized access, misuse, modification, or denial of the computer network and network-accessible resources. Network Security is the authorization of access to data within a network. Typically, users are assigned an identification (ID), such as a user name, and a password that allows the users access to information and programs on a network within their security level clearance. In other words, network security secures the network by protecting and overseeing operations being performed. However, when a password is sent over a network, a risk exists that the password will be intercepted by an unauthorized user and the user identification credential stolen. Data encryption, digital certificates, virtual private networks (VPN), tunneling, and the like may be helpful to increase network security, but not in every case.

### SUMMARY

According to one embodiment of the present invention, a computer implemented method for authenticating a password is provided. An authentication server device receives a plurality of password segments associated with a password from a client device over a plurality of communication channels. The authentication server device reconstructs the password from the plurality of password segments based on a particular set of parameters identified by a selected session key identification number. Then, the authentication server device sends the reconstructed password to a target device for comparison with a stored password associated with the client device. If the stored password matches the reconstructed password, then the target device establishes a session with the client device so that the client device may access a resource located on the target device. In addition, the authentication server device closes the plurality of communication channels established with the client device in response to the authentication server receiving a notification from the target device that the reconstructed password did match the stored password associated with the client device.

### BRIEF DESCRIPTION OF THE SEVERAL VIEWS OF THE DRAWINGS

FIG. 1 is a pictorial representation of a network of data processing systems in which illustrative embodiments may be implemented;

FIG. 2 is a diagram of a data processing system in which illustrative embodiments may be implemented;

FIG. 3 is a diagram of a password authentication system in accordance with an illustrative embodiment;

FIG. 4 is a diagram illustrating an example of a segmented password in accordance with an illustrative embodiment;

FIG. 5 is a diagram illustrating an example of password authentication in accordance with an illustrative embodiment;

FIG. 6 is a specific example of a security scheme table in accordance with an illustrative embodiment;

FIG. 7 is a flowchart illustrating a process for a client device in accordance with an illustrative embodiment;

FIG. 8 is a flowchart illustrating a process for an authentication server device in accordance with an illustrative embodiment; and

FIG. 9 is a flowchart illustrating a process for a target device in accordance with an illustrative embodiment.

### DETAILED DESCRIPTION

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “circuit,” “module,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

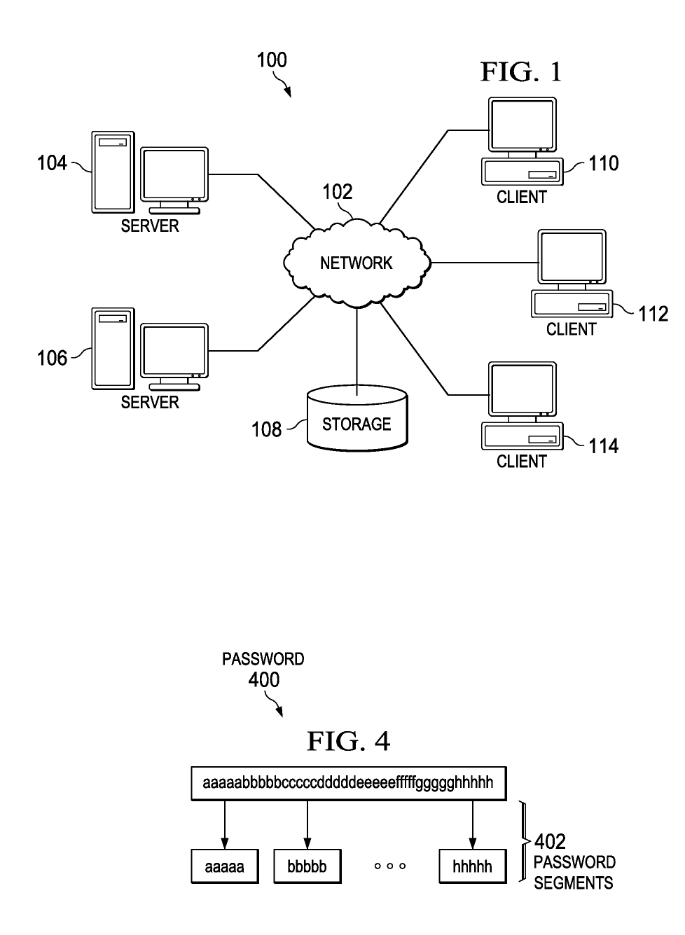

With reference now to the figures, and in particular, with reference to FIGS. 1-3, diagrams of data processing environments are provided in which illustrative embodiments may be implemented. It should be appreciated that FIGS. 1-3 are only meant as examples and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers and other devices in which the illustrative embodiments may be implemented. Network data processing system 100 contains network 102, which is the medium used to provide communications links between the computers and the other various devices connected together within network data processing system 100. Network 102 may include connections, such as wire, wireless communication links, or fiber optic cables.

In the depicted example, server 104 and server 106 connect to network 102, along with storage unit 108. Server 104 may, for example, be an authentication server device that illustrative embodiments use to reconstruct a network security password from a plurality of password segments sent to the authentication server by a client device via a plurality of communication channels in parallel at a same time. Reconstructing a network security password means to place the network security password back into its original form using the plurality of password segments that were generated from the original network security password prior to transmission. In addition, server 106 may, for example, be a target device that is protected by server 104 and includes protected resources, such as applications and/or confidential data. A protected resource is a resource not available for unrestricted public access. In other words, a password is required to access a protected resource on server 106. The application may, for example, be a medical services application associated with a medical institution and the confidential data may, for example, be a user's medical history. Further, server 104 and server 106 may each represent a plurality of servers.

Storage unit 108 is a network storage device capable of storing data in a structured or unstructured format. The data stored in storage unit 108 may be data of any type. Storage unit 108 may be a local database or a remote database.

Clients 110, 112, and 114 also connect to network 102. Client computers 110, 112, and 114 may, for example, be personal computers or network computers. In the depicted example, server computer 104 provides information, such as boot files, operating system images, and applications to client computers 110, 112, and 114. Client computers 110, 112, and 114 are clients to server computer 104 and server computer 106. In addition, client computers 110, 112, and 114 may request access to resources located on server computer 106. Also, network data processing system 100 may include additional server computers, client computers, and other devices not shown.

Program code located in network data processing system 100 may be stored on a computer recordable storage medium and downloaded to a computer or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

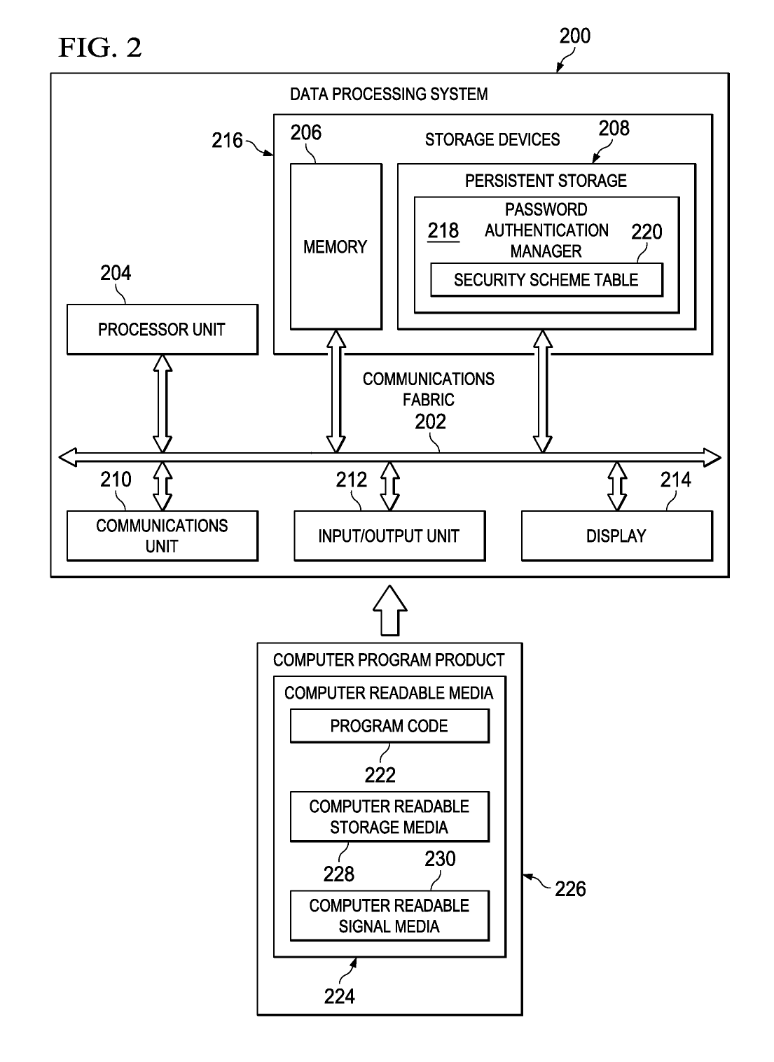

With reference now to FIG. 2, a diagram of a data processing system is depicted in accordance with an illustrative embodiment. Data processing system 200 is an example of a computer, such as server 104 or client 110 in FIG. 1, in which computer usable program code or instructions implementing processes of illustrative embodiments may be located. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software applications or programs that may be loaded into memory 206. Processor unit 204 may be a set of one or more processors or may be a multi-processor core, depending on the particular implementation. Further, processor unit 204 may be implemented using one or more heterogeneous processor systems, in which a main processor is present with secondary processors on a single chip. As another illustrative example, processor unit 204 may be a symmetric multi-processor system containing multiple processors of the same type.

Memory 206 and persistent storage 208 are examples of storage devices 216. A storage device is any piece of hardware that is capable of storing information, such as, for example, without limitation, data, program code in functional form, and/or other suitable information either on a transient basis and/or a persistent basis. Memory 206, in these examples, may, for example, be a random access memory, or any other suitable volatile or non-volatile storage device. Persistent storage 208 may take various forms, depending on the particular implementation. For example, persistent storage 208 may contain one or more devices. For example, persistent storage 208 may be a hard drive, a flash memory, a rewritable optical disk, a rewritable magnetic tape, or some combination of the above. The media used by persistent storage 208 may be removable. For example, a removable hard drive may be used for persistent storage 208.

Persistent storage 208 stores password authentication manager 218. Password authentication manager 218 may, for example, be a software application that was received or downloaded from an authentication server device, such as server 104 in FIG. 1. Password authentication manager 218 provides control of processes of illustrative embodiments. For example, password authentication manager 218 may control processes for: segmenting passwords into a predetermined number of password segments; encrypting passwords prior to or after the segmentation process; rearranging or mixing up password segments in an out-of-order sequence; establishing a predetermined number of communication channels between an authentication server device and a client device; establishing dummy communication channels to transmit dummy password segments; inserting dummy values into a password prior to segmentation of the password; and reconstructing passwords from encrypted out-of-order password segments. Also, even though password authentication manager 218 is shown within one data processing system in this example, it should be noted that password authentication manager 218 may be distributed in a plurality of data processing systems throughout a network of data processing systems, such as network data processing system 100 in FIG. 1.

In addition, password authentication manager 218 includes security scheme table 220. Security scheme table 220 is a table that stores a plurality of sets of security parameters that define how password authentication manager 218 is to perform the processes of illustrative embodiments. It should be noted that security scheme table 220 may represent a plurality of security scheme tables, each security scheme table being associated with a particular user and identified by a specific user identifier associated with each particular user.

Security scheme table 220, in addition to listing the user identifier, may, for example, include data, such as a session key identifier, the number of communication channels to establish, the number of password segments to generate from a password, the correct order of mixed up password segments, whether to encrypt a password prior to segmentation of the password, whether to also establish dummy communication channels along with the valid communication channels, whether to intersperse dummy password values among valid password values within a password prior to segmentation of the password, where to locate the dummy password value positions within a password, and whether intermittent password authentication is to be performed after initial password authentication and in what time interval the intermittent password authentication is to be performed. A session key identifier is an identifier, such as an ID number, that identifies a particular set of password authentication parameters within the plurality of sets of parameters stored in security scheme table 220 that is associated with a particular online session. Security scheme table 220 may include other information as well, such as how long a password is to be and which internet protocol (IP) addresses are to be used.

Communications unit 210, in this example, provides for communication with other data processing systems or devices. In this example, communications unit 210 is a network interface card. Communications unit 210 may provide communications through the use of either or both physical and wireless communications links.

Input/output unit 212 allows for the input and output of data with other devices that may be connected to data processing system 200. For example, input/output unit 212 may provide a connection for user input through a keyboard, a mouse, and/or some other suitable input device. Further, input/output unit 212 may send output to a printer. Display 214 provides a mechanism to display information to a user.

Instructions for the operating system, applications, and/or programs may be located in storage devices 216, which are in communication with processor unit 204 through communications fabric 202. In this illustrative example, the instructions are in a functional form on persistent storage 208. These instructions may be loaded into memory 206 for running by processor unit 204. The processes of the different embodiments may be performed by processor unit 204 using computer implemented instructions, which may be located in a memory, such as memory 206. These instructions are referred to as program code, computer usable program code, or computer readable program code that may be read and run by a processor in processor unit 204. The program code, in the different embodiments, may be embodied on different physical or computer readable storage media, such as memory 206 or persistent storage 208.

Program code 222 is located in a functional form on computer readable media 224 that is selectively removable and may be loaded onto or transferred to data processing system 200 for running by processor unit 204. Program code 222 and computer readable media 224 form computer program product 226. In one example, computer readable media 224 may be computer readable storage media 228 or computer readable signal media 230. Computer readable storage media 228 may include, for example, an optical or magnetic disc that is inserted or placed into a drive or other device that is part of persistent storage 208 for transfer onto a storage device, such as a hard drive, that is part of persistent storage 208. Computer readable storage media 228 also may take the form of a persistent storage, such as a hard drive, a thumb drive, or a flash memory that is connected to data processing system 200. In some instances, computer readable storage media 228 may not be removable from data processing system 200.

Alternatively, program code 222 may be transferred to data processing system 200 using computer readable signal media 230. Computer readable signal media 230 may be, for example, a propagated data signal containing program code 222. For example, computer readable signal media 230 may be an electro-magnetic signal, an optical signal, and/or any other suitable type of signal. These signals may be transmitted over communication links, such as wireless communication links, an optical fiber cable, a coaxial cable, a wire, and/or any other suitable type of communications link. In other words, the communications link and/or the connection may be physical or wireless in the illustrative examples. The computer readable media also may take the form of non-tangible media, such as communication links or wireless transmissions containing the program code.

In some illustrative embodiments, program code 222 may be downloaded over a network to persistent storage 208 from another device or data processing system through computer readable signal media 230 for use within data processing system 200. For instance, program code stored in a computer readable storage media in a server data processing system may be downloaded over a network from the server to data processing system 200. The data processing system providing program code 222 may be a server computer, a client computer, or some other device capable of storing and transmitting program code 222.

The different components illustrated for data processing system 200 are not meant to provide architectural limitations to the manner in which different embodiments may be implemented. The different illustrative embodiments may be implemented in a data processing system including components in addition to, or in place of, those illustrated for data processing system 200. Other components shown in FIG. 2 can be varied from the illustrative examples shown. The different embodiments may be implemented using any hardware device or system capable of executing program code. As one example, data processing system 200 may include organic components integrated with inorganic components and/or may be comprised entirely of organic components excluding a human being. For example, a storage device may be comprised of an organic semiconductor.

As another example, a storage device in data processing system 200 is any hardware apparatus that may store data. Memory 206, persistent storage 208, and computer readable media 224 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Illustrative embodiments provide a computer implemented method, data processing system, and computer program product for authenticating a password. An authentication server device receives a plurality of password segments associated with a password from a client device over a plurality of communication channels in parallel at a same time. The authentication server device reconstructs the password from the plurality of password segments based on a particular set of parameters identified by a selected session key identification number. Reconstructing the password from the plurality of password segments means to restore the password back to the password's original form prior to the segmentation of the password into the plurality of password segments. In other words, reconstructing the password means to put the password back together using the password segments that were generated from the password prior to sending the password segments over the communication channels. Then, the authentication server device sends the reconstructed password to a target device for comparison with a stored password associated with the client device. If the stored password matches the reconstructed password, then the target device establishes a session directly with the client device so that the client device may access a resource located on the target device. In addition, the authentication server device closes the plurality of communication channels established with the client device in response to the authentication server receiving a notification from the target device that the reconstructed password does match the stored password associated with the client device.

Illustrative embodiments overcome network security exposure issues even when intrusion at the communication channel level exists. The concept behind illustrative embodiments is similar to what occurs in the banking industry when a key that opens a safety deposit box is built with multiple pieces, each piece being held by a different individual. The basic concept of illustrative embodiments is to split a single logon password into a predetermined number of logon password segments. In other words, the user logon password is divided into a plurality of smaller password segments or tokens. In addition, the password segments may be rearranged or mixed up in an out-of-order sequence according to a variable algorithm known to the sending client device and the receiving authentication server device. The out-of-order password segments are then sent in parallel at a same time over multiple communication channels established between the sending client device and the receiving authentication server device. If the receiving authentication server device is able to reconstruct the original logon password from the out-of-order password segments, then the session logon is accepted.

An advantage to using illustrative embodiments is that the complexity level for the network security is increased. For example, an unauthorized user is required to intercept multiple parallel communication channels at the same time to acquire the password. In addition, the unauthorized user does not know which scheme to utilize to re-order the out-of-order password segments because the scheme is changed for each password authentication process. Furthermore, illustrative embodiments may further increase the complexity level of the network security by using dummy communication channels that only transmit dummy password segments. Thus, the unauthorized user is not able to determine which communication channels are transmitting valid password segments and which are transmitting dummy password segments. A valid password segment is a segment of the password that contains valid password values or characters. A dummy password segment is a segment that contains only invalid values or garbage and does not contain any valid password values of the password. Also, illustrative embodiments may increase the complexity level of the network security by interspersing dummy password values among valid password values in each password segment based on a predetermined set of security parameters that identifies the positions of the valid and dummy values within each password segment. A valid password value is an actual password value created by a particular user of a client device used to access a network and/or a protected resource. A dummy password value is an invalid password value or garbage.

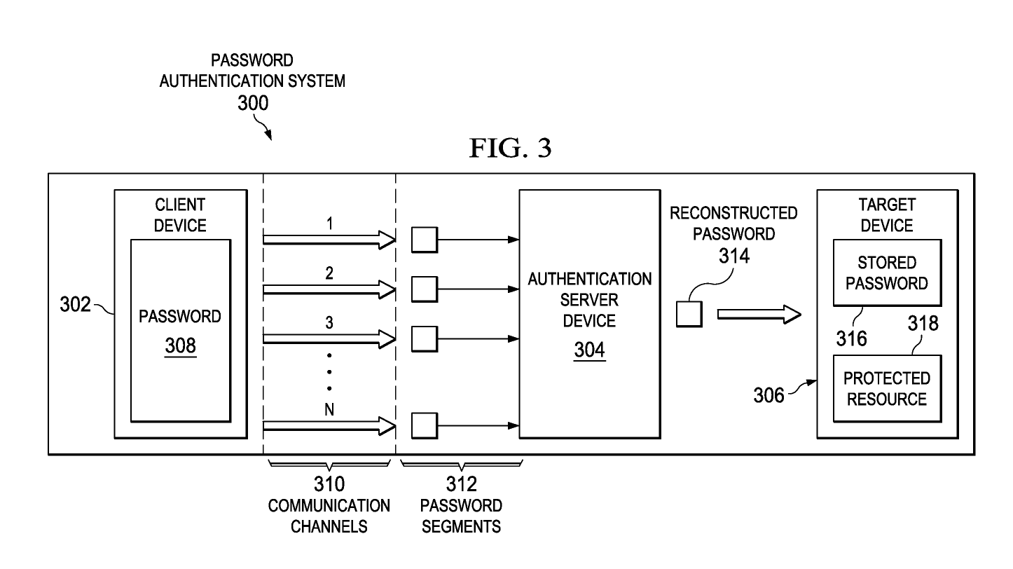

With reference now to FIG. 3, a diagram of a password authentication system is depicted in accordance with an illustrative embodiment. Password authentication system 300 includes client device 302, authentication server device 304, and target device 306. Password authentication system 300 may, for example, be implemented in network data processing system 100 in FIG. 1. In addition, it should be noted that client device 302, authentication server device 304, and target device 306 are connected by two or more networks.

Client device 302 may, for example, be client 110 in FIG. 1. In this example, client device 302 desires access to protected resource 318 on target device 306. Target device 306 may, for example, be server 106 in FIG. 1. Client 302 sends password 308 to authentication server device 304 via communication channels 310 in a predetermined number of password segments, such as password segments 312. Authentication server device 304 may, for example, be server 104 in FIG. 1. One password segment is sent per one communication channel in parallel at a same time with the other password segments associated with the password. Alternatively, two or more password segments may be sent in an out-of-order sequence on a same communication channel if the predetermined number of password segments is greater than the number of established communication channels. The number of password segments and the number of communications channels established to transmit the password segments is defined by a selected set of security parameters identified by a session key identifier, which is selected by authentication server device 304 for the online session.

Authentication server device 304 reconstructs the segmented password based on the selected set of parameters to form reconstructed password 314. Reconstructed password 314 is password 308 put back together using password segments 312, which were generated from password 308 prior to sending password segments 312 over communication channels 310. Authentication server device 304 sends reconstructed password 314 to target device 306. Target device 306 compares reconstructed password 314 with stored password 316. Stored password 316 is a stored password associated with client device 302 and is the same password as password 308 and reconstructed password 314. If a match is found between reconstructed password 314 and stored password 316, then target device 306 permits client device 302 access to protected resources located on target device 306.

The process starts when a user of client device 302 wants to connect and logon to target device 306 to access protected resource 318 located on target device 306. Protected resource 318 may, for example, be an application or confidential data. In addition, protected resource 318 may represent a plurality of different protected resources on target device 306. Target device 306 is a remote data processing system that is outside of client device 302's network. Target device 306 forwards the logon request received from client device 302 to authentication server device 304 for processing. At this point, authentication server device 304 requests the user of client device 302 to provide the appropriate credentials, such as user password, for accessing the protected resource located on target device 306. In addition to requesting the appropriate password, authentication server device 304 sends to client device 302 a selected session key identification number from a plurality of session key identification numbers. The selected session key identification number specifically identifies a particular set of parameters from a plurality of sets of parameters that define how client device 302 and authentication server device 304 are to process password 308 and password segments 312.

After receiving the selected session key identification number from authentication server device 304, client device 302 uses a secure software application, such as password authentication manager 218 in FIG. 2, to establish a predetermined number of parallel communication channels, such as communication channels 310, with authentication server device 304 based on the particular set of parameters identified by the selected session key identification number. Further, the password authentication manager application automatically segments password 308 into a predetermined number of password segments, such as password segments 312. In addition, the password authentication manager application may encrypt each password segment in password segments 312. Alternatively, the password authentication manager application may encrypt password 308 prior to segmentation of password 308. Furthermore, the password authentication manager application may rearrange or mix up password segments 312 in an out-of-order sequence. Then, the password authentication manager application sends each password segment in password segments 312 to authentication server device 304 via one communication channel in communication channels 310 in parallel at a same time.

The different security schemes are known in advance by client device 302 and authentication server device 304. The different security schemes or sets of security parameters are pre-defined and pre-shipped prior to session connection. For example, the different security schemes or sets of security parameters are included in a security scheme table within the password authentication manager application when the password authentication manager application is installed on or downloaded to client device 302. In addition, a plurality of different security scheme tables associated with a plurality of different client users is stored on authentication server device 304. Each of the different security scheme tables stored on authentication server device 304 are identified by, for example, a different user ID that is unique to each client user.

Authentication server device 304 decrypts each of the received password segments 312 and reconstructs password 308 to form reconstructed password 314 by rearranging the mixed up out-of-order password segments based on the particular set of parameters identified by the selected session key identification number, which has been agreed upon prior to establishing the session. Alternatively, authentication server device 304 reconstructs password 308 from password segments 312 prior to decrypting password 308. For example, authentication server device 304 may select session key identification number 5, which may define segmentation and reconstruction of a sequence of 6 password segments for password 308 in the following order: password segment 2, password segment 3, password segment 1, password segment 4, password segment 6, and password segment 5. In addition, selected session key identification number 5 may require 6 parallel communication channels 310 to be established between authentication server device 304 and client device 302 for sending the required 6 password segments in parallel at a same time.

Alternatively, selected session key identification number 5 may require only 3 parallel communication channels 310 to be established for sending in parallel 2 password segments consecutively over each of the 3 established communication channels. For example, password segment 2 and password segment 3 may be sent consecutively over communication channel 1; password segment 1 and password segment 4 may be sent consecutively over communication channel 2; and password segment 6 and password segment 5 may be sent consecutively over communication channel 3. Or alternatively, selected session key identification number 5 may require 8 parallel communication channels 310 to be established for sending the 6 valid password segments over 6 of the 8 required communication channels and 2 dummy password segments over the 2 remaining communication channels in parallel at the same time. For example, valid password segments 4, 1, 6, 2, 3, and 5 are sent over communication channels 1, 2, 3, 4, 6, and 8, respectively, while dummy password segments 7 and 8 are sent over communication channels 5 and 7, respectively, in parallel at a same time.

Then, authentication server device 304 sends reconstructed password 314 to target device 306. If reconstructed password 314 matches stored password 316 associated with client device 302 stored in target device 306, then target device 306 establishes a session between target device 306 and client device 302 directly and notifies authentication server device 304 to close communication channels 310 established between authentication server device 304 and client device 302.

Moreover, if password 308 is not long enough to make up the predetermined number of password segments required to transmit over the predetermined number of communication channels defined by the particular set of security parameters identified by the selected session key identification number, then a portion of password segments 312 may be dummy password segments transmitted over dummy communication channels located within communication channels 310. Further, based on the particular set of security parameters identified by the selected session key identification number, each of the password segments may contain a set of valid password values interspersed with a set of dummy password values. For example, based on selected session key identification number 5, the valid password values to be used when reconstructing password 308 are the 2^{nd} value position, the 5^{th} value position, and the 8^{th} value position in a password segment, all other positions in the password segment contain dummy password values.

However, illustrative embodiments may reduce the complexity of the network security scheme by limiting the number of established communication channels between client device 302 and authentication server device 304. For example, the number of communication channels established between client device 302 and authentication server device 304 may be limited to one, over which the mixed up out-of-order password segments are transmitted one after the other.

Also, it should be noted that client device 302, authentication server device 304, and target device 306 are secure devices, which means that each device employs network security. Further, it should be noted that authentication server device 304 and communication channels 310 are only required during session start up. However, periodic password authentication may be performed on a predetermined time interval basis after initial password authentication when, for example, dealing with confidential data during a session between client device 302 and target device 306. A periodic password authentication can be put in place to verify the identity of the parties in a session, which is performed automatically in the background over parallel communication channels. If during the intermittent password authentication process the session is found to be “corrupted,” then authentication server device 304 traces the session, alerts appropriate personnel, such as system administrators, and terminates the session immediately.

With reference now to FIG. 4, a diagram illustrating an example of a segmented password is depicted in accordance with an illustrative embodiment. Password 400 may, for example, be password 308 in FIG. 3. Password 400 is a network security password associated with a particular user used to gain access to a network and/or a protected resource. In this example, password 400 contains a set of 40 values in a particular sequence.

However, it should be noted that password 400 is only intended as an example and is not intended to be a limitation on illustrative embodiments. Password 400 may be of any length and contain any combination of different values, characters, or symbols. The length of password 400 may, for example, be defined in a set of security parameters found in a security scheme table that is identified by a session key identification number selected by an authentication server device, such as authentication server device 304 in FIG. 3.

Also in this example, password 400 is segmented or divided into password segments 402. A client device, such as client device 302 in FIG. 3, may segment password 400 to generate password segments 402. Each of the password segments within password segments 402 contains a subset of values from password 400. In this example, each of the password segments within password segments 402 contains a subset of values of equal length, 5 values per password segment. However, it should be noted that the client device may segment password 400 into equal size password segments, into unequal size password segments, or into a combination of equal sized and unequal sized password segments.

Further, password 400 may include both valid password values and dummy password values. The valid password values are the actual password values created by a particular user of the client device used to access a network and/or a protected resource. For example, the password values aaaaa, bbbbb, and hhhhh may be the valid password values created by the user.

The dummy password values are invalid or garbage password values inserted into password 400 by, for example, a password authentication manager application located on the client device, such as password authentication manager 218 in FIG. 2. The dummy password values are inserted into password 400 to make it more difficult for an unauthorized user to determine the valid password values created by the user. The password authentication manager inserts the dummy password values into password 400 based on the particular set of security parameters identified by the session key identification number selected by the authentication server device. In this example, password values ccccc, ddddd, eeeee, fffff, and ggggg may be dummy password values inserted between valid password values bbbbb and hhhhh. In addition, the password authentication manager may use the dummy password values to generate dummy password segments within password segments 402. A dummy password segment contains only garbage or useless data.

However, it should be noted that the dummy password values may be interspersed or intermingled with valid password values. For example, in a password segment that contain 5 password values, password values in positions 1, 3, and 5 may represent the valid password values and password values in positions 2 and 4 may represent the dummy password values. This same interspersing scheme may be used for all password segments 402 or a different interspersing scheme may be used for each password segment within password segments 402. The particular scheme used to intersperse dummy password values among valid password values is defined by the particular set of security parameters identified by the session key identification number selected by the authentication server device.

Furthermore, the password authentication manager may encrypt password 400 prior to generating password segments 402. Alternatively, the password authentication manager may encrypt password segments 402 subsequent to segmentation of password 400. The password authentication manager uses the particular set of security parameters identified by the session key identification number selected by the authentication server device to determine whether to encrypt password 400 or password segments 402.

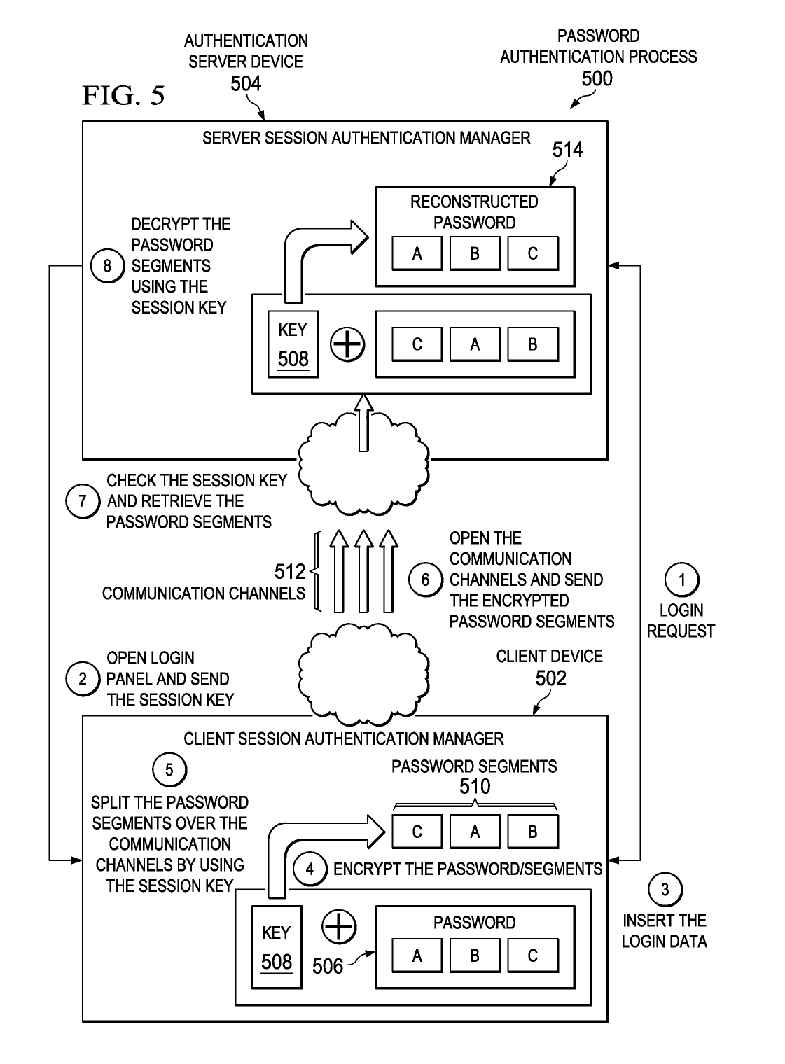

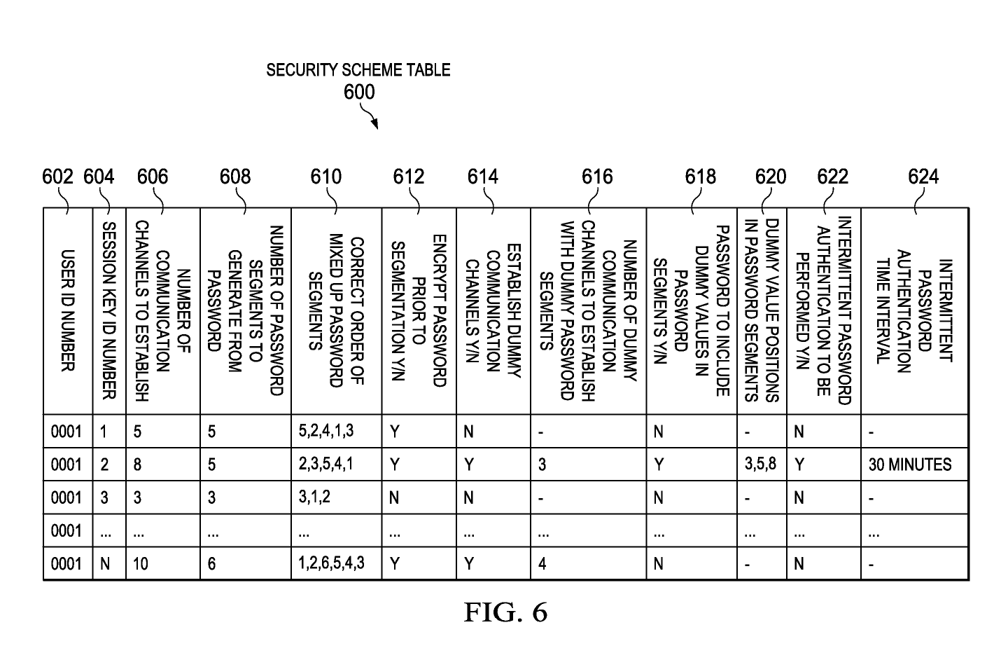

With reference now to FIG. 5, a diagram illustrating an example of password authentication is depicted in accordance with an illustrative embodiment. Password authentication process 500 may be implemented in network data processing system 100 in FIG. 1. Password authentication process 500 includes client device 502 and authentication server device 504, such as client device 302 and authentication server device 304 in FIG. 3.

The process begins at step 1 when authentication server device 504 receives a login request associated with client device 502 to access a resource on a target device, such as protected resource 318 on target device 306 in FIG. 3. At step 2, authentication server device 504 opens a login panel for client device 502 and sends a session key identification number to client device 502. The session key identification number in this example is represented by key 508. At step 3, client device 502 inserts the login data, such as user ID and password, in the login panel.

At step 4, client device 502 encrypts password 506. Alternatively, client device 502 encrypts password segments 510 after segmentation of password 506. At step 5, client device 502 splits password segments over communication channels 512 based on a set of security parameters identified by the session key identification number received from authentication server device 504. Communication channels 512 may, for example, be communication channels 310 in FIG. 3.

At step 6, client device 502 opens communication channels 512 with authentication server device 504 and sends encrypted password segments 510 to authentication server device 504. Also, it should be noted that the sequence of password segments in password 506 is a, b, c. However, the sequence of password segments 508 is c, a, b. In other words, client device 502 rearranged or mixed up the password segments in an out-of-order sequence prior to sending encrypted password segments 510 to authentication server device 504.

At step 7, authentication server device 504 checks the session key identification number represented by key 508 and retrieves password segments 510. Then at step 8, authentication server device 504 decrypts password segments 510 using the set of security parameters identified by key 508. Moreover, authentication server device 504 rearranges decrypted password segments 510 in a correct sequence using the set of security parameters identified by key 508 to form reconstructed password 514. It should be noted that reconstructed password 514 is the same as Password 506. Afterward, authentication server device 504 sends reconstructed password 514 to the target device for comparison with a stored password associated with client device 502 for validation of reconstructed password 514. The stored password may, for example, be stored password 316 in FIG. 3.

With reference now to FIG. 6, a specific example of a security scheme table is depicted in accordance with an illustrative embodiment. Security scheme table 600 may, for example, be security scheme table 220 in FIG. 2. Security scheme table 600 is a table associated with a particular user of a client device that is identified by a user identifier, such as user identification number 602. Security scheme table 600 is stored on the client device and on an authentication server device. The client device and the authentication server device may, for example, be client device 302 and authentication server device 304 in FIG. 3.

Security scheme table 600 includes a plurality of sets of security parameters that define how the client device and the authentication server device are to perform processes of illustrative embodiments. For example, the sets of security parameters define how to segment a password, such as password 506 in FIG. 5, how to transmit the password segments, such as password segments 510 in FIG. 5, and how to reconstruct the password segments to form a reconstructed password, such as reconstructed password 514 in FIG. 5. Of course, security scheme table 600 is only intended as an example and not meant to be a limitation on illustrative embodiments.

In addition to user identification number 602, security scheme table 600 includes session key identification number 604, number of communication channels to establish 606, number of password segments to generate from password 608, correct order of mixed up password segments 610, encrypt password prior to segmentation Yes/No 612, establish dummy communication channels Yes/No 614, number of dummy communication channels to establish with dummy password segments 616, password to include dummy values in password segments Yes/No 618, dummy value positions in password segments 620, intermittent password authentication to be performed Yes/No 622, and intermittent password authentication time interval 624. User identification number 602 associates security scheme table 600 with a particular user. It should be noted that security scheme table 600 is one of a plurality of different security scheme tables associated with a plurality of different users.

Session key identification number 604 identifies a particular set of security parameters listed in the corresponding row of security scheme table 600. Each time a new session key identification number is selected by the authentication server device, all password authentication system behavior changes, making it more difficult to intercept the user created password. Number of communication channels to establish 606 defines the number of communication channels, such as communication channels 512 in FIG. 5, the client device is to establish with the authentication server device. Number of password segments to generate from password 608 defines the number of password segments, such as password segments 510 in FIG. 5, the client device is to generate from a password, such as password 506 in FIG. 5. Correct order of mixed up password segments 610 defines the correct order of the password segments for the authentication server device to reconstruct the password from the password segments.

Encrypt password prior to segmentation Yes/No 612 defines whether the client device is to encrypt the password prior to segmentation of the password into the predetermined number of password segments. Establish dummy communication channels Yes/No 614 defines whether the client device is to also establish dummy communication channels with the authentication server device. These additional dummy communication channels are not carrying user created password data, but are only used to generate “noise” to make it more difficult to intercept the user created password. Number of dummy communication channels to establish with dummy password segments 616 defines the number of dummy communication channels the client device is to establish with the authentication server device that transmit dummy password segments.

Password to include dummy values in password segments Yes/No 618 defines whether the client device is to intersperse dummy password values among valid password values in the password prior to segmentation of the password. Dummy value positions in password segments 620 defines the value positions within the password segments that contain dummy password values for the authentication server device to reconstruct the password using only the valid password values. Intermittent password authentication to be performed Yes/No 622 defines whether the authentication server device is to perform intermittent password authentication processes in the background during an established session between the client device and the target device. Intermittent password authentication time interval 624 defines the time intervals when the authentication server device is to perform the intermittent password authentication process. Further, security scheme table may define other information as well, such as the length of the password and the IP addresses to be used by processes.

In this illustrated example, session key identification number 1 identifies a particular set of security parameters contained in its corresponding row in security scheme table 600. For example, the particular set of security parameters identified by session key identification number 1 is as follows: the number of communication channels to establish is 5; the number of password segments to generate from the password is 5; the correct order of the mixed up password segments is 5, 2, 4, 1, 3; the decision to encrypt the password prior to segmentation is Yes; the decision to establish dummy communication channels is No; the number of dummy communication channels to establish with dummy password segments is null because the decision to establish dummy communication channels is No; the decision to include dummy values in the password segments is No; the dummy value positions within the password segments is null because the decision to include dummy values in the password segments is No; the decision to perform intermittent password authentication is No; and the intermittent password authentication time interval is null because the decision to perform intermittent password authentication is No.

As a further example, the particular set of security parameters identified by session key identification number 2 is as follows: the number of communication channels to establish is 8; the number of password segments to generate from the password is 5; the correct order of the mixed up password segments is 2, 3, 5, 4, 1; the decision to encrypt the password prior to segmentation is Yes; the decision to establish dummy communication channels is Yes because the required number of communication channels to establish is 8 and the number of password segments in only 5 (i.e., one password segment per one communication channel); the number of dummy communication channels to establish with dummy password segments is 3 because 8 total communication channels are required; the decision to include dummy values in the password segments is Yes; the dummy value positions within the password segments is 3, 5, and 8; the decision to perform intermittent password authentication is Yes; and the intermittent password authentication time interval is 30 minutes. However, it should be noted that illustrative embodiments may utilize any time interval period to perform intermittent password authentication.

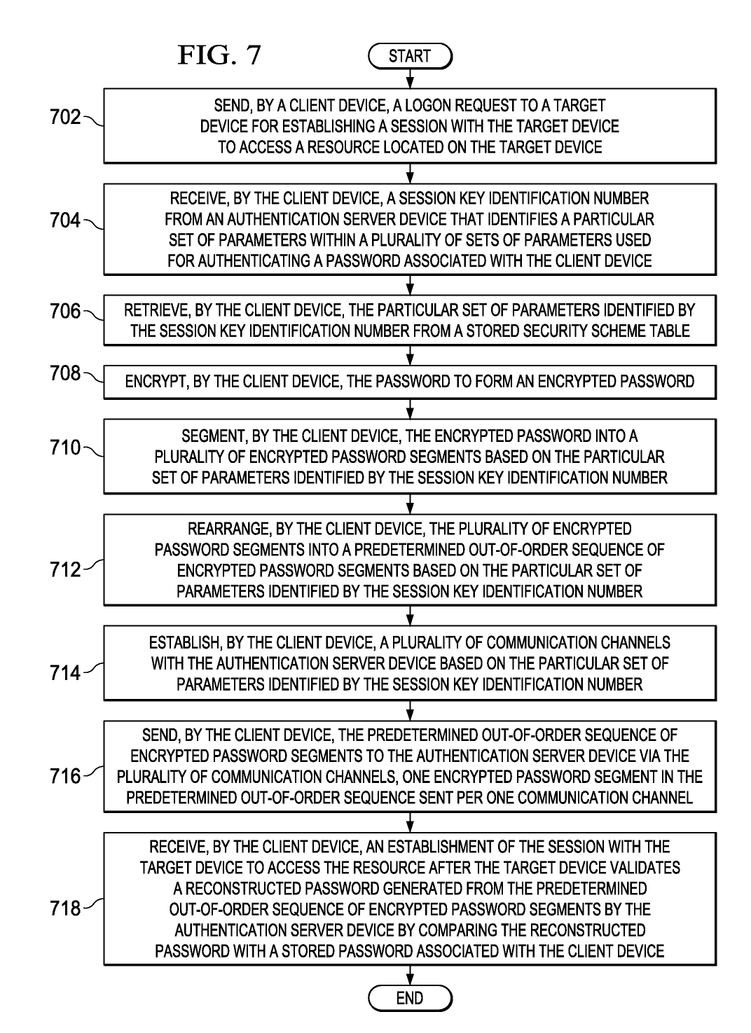

With reference now to FIG. 7, a flowchart illustrating a process for a client device is shown in accordance with an illustrative embodiment. The process shown in FIG. 7 may be implemented in a client device, such as, for example, client device 302 in FIG. 3.

The process starts when the client device sends a logon request to a target device for establishing a session with the target device to access a resource located on the target device (step 702). The target device may, for example, be target device 306 in FIG. 3. The resource may, for example, be protected resource 318 in FIG. 3 and may be an application or confidential data located on the target device.

Then, the client device receives a session key identification number from an authentication server device that identifies a particular set of parameters within a plurality of sets of parameters used for authenticating a password associated with the client device (step 704). The session key identification number may, for example, be session identification number 604 in FIG. 6. The authentication server device may, for example, be authentication server device 304 in FIG. 3. The password associated with the client device may, for example, be password 308 in FIG. 3.

After receiving the session key identification number from the authentication server device that identifies the particular set of parameters in step 704, the client device retrieves the particular set of parameters identified by the session key identification number from a stored security scheme table (step 706). The particular set of parameters identified by the session key identification number may, for example, be the data contained in the corresponding row of the session key identification number. The stored security scheme table may, for example, be security scheme table 600 in FIG. 6.

Then, the client device encrypts the password to form an encrypted password (step 708). Subsequent to encrypting the password in step 708, the client device segments the encrypted password into a plurality of encrypted password segments based on the particular set of parameters identified by the session key identification number (step 710). The plurality of encrypted password segments may, for example, be password segments 510 in FIG. 5. In addition, the client device rearranges the plurality of encrypted password segments into a predetermined out-of-order sequence of encrypted password segments based on the particular set of parameters identified by the session key identification number (step 712).

Then, the client device establishes a plurality of communication channels with the authentication server device based on the particular set of parameters identified by the session key identification number (step 714). The plurality of communication channels may, for example, be communication channels 512 in FIG. 5. Subsequently, the client device sends the predetermined out-of-order sequence of encrypted password segments to the authentication server device via the plurality of communication channels (step 716). The client device sends one encrypted password segment in the predetermined out-of-order sequence per one communication channel in parallel at a same time to the authentication server device.

Afterward, the client device receives an establishment of the session with the target device to access the resource after the target device validates a reconstructed password generated from the predetermined out-of-order sequence of encrypted password segments by the authentication server device by comparing the reconstructed password with a stored password associated with the client device (step 718). The reconstructed password and the stored password may, for example, be reconstructed password 314 and stored password 316 in FIG. 3. The process terminates thereafter.

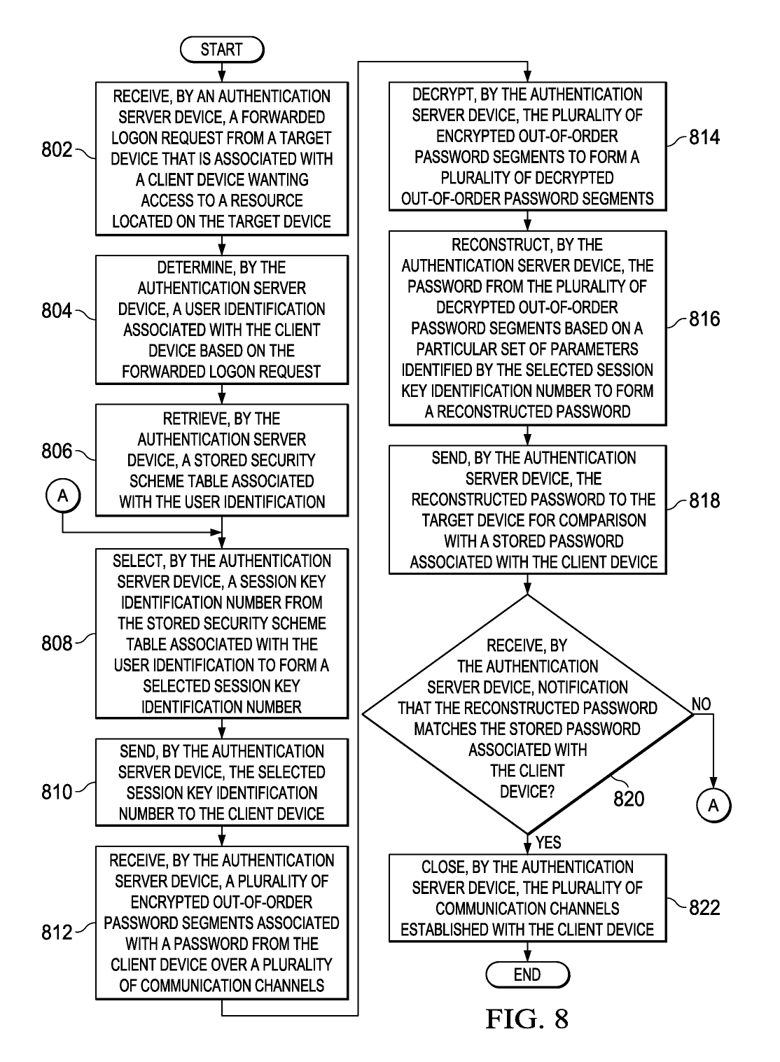

With reference now to FIG. 8, a flowchart illustrating a process for an authentication server device is shown in accordance with an illustrative embodiment. The process shown in FIG. 8 may be implemented in an authentication server device, such as, for example, authentication server device 304 in FIG. 3.

The process starts when the authentication server device receives a forwarded logon request from a target device that is associated with a client device wanting access to a resource located on the target device (step 802). The resource located on the target device may, for example, be protected resource 318 located on target device 306 in FIG. 3. The client device may, for example, be client device 302 in FIG. 3.

After receiving the forwarded logon request from the target device in step 802, the authentication server device determines a user identification associated with the client device based on the forwarded logon request (step 804). The user identification may, for example, be user identification number 602 in FIG. 6. Then, the authentication server device retrieves a stored security scheme table associated with the user identification (step 806). The stored security scheme table may, for example, be security scheme table 600 in FIG. 6. In addition, it should be noted that the authentication server device stores a plurality of different security scheme tables, each associated with a different client device user.

Subsequent to retrieving the stored security scheme table in step 806, the authentication server device selects a session key identification number from the stored security scheme table associated with the user identification to form a selected session key identification number (step 808). The selected session key identification number may, for example, be session key identification number 604 in FIG. 6. Then, the authentication server device sends the selected session key identification number to the client device (step 810).

Subsequently, the authentication server device receives a plurality of encrypted out-of-order password segments associated with a password from the client device over a plurality of communication channels (step 812). The plurality of encrypted out-of-order password segments associated with the password may, for example, be password segments 510 associated with password 506 in FIG. 5. The plurality of communication channels may, for example, be communication channels 512 in FIG. 5.

After receiving the plurality of encrypted out-of-order password segments associated with the password in step 812, the authentication server device decrypts the plurality of encrypted out-of-order password segments to form a plurality of decrypted out-of-order password segments (step 814). Then, the authentication server device reconstructs the password from the plurality of decrypted out-of-order password segments based on a particular set of parameters identified by the selected session key identification number to form a reconstructed password (step 816). The particular set of parameters identified by the session key identification number may, for example, be the data contained in the corresponding row of the session key identification number. The reconstructed password may, for example, be reconstructed password 314 in FIG. 3.

Subsequent to reconstructing the password in step 816, the authentication server device sends the reconstructed password to the target device for comparison with a stored password associated with the client device (step 818). The stored password may, for example, be stored password 316 in FIG. 3. Then, the authentication server device makes a determination as to whether the authentication server device receives a notification from the target device that the reconstructed password matches the stored password associated with the client device (step 820). If the authentication server device receives a notification from the target device that the reconstructed password does match the stored password associated with the client device, yes output of step 820, then the authentication server device closes the plurality of communication channels established with the client device (step 822) and the process terminates thereafter. If the authentication server device receives a notification from the target device that the reconstructed password does not match the stored password associated with the client device, no output of step 820, then the process returns to step 808 where the authentication server device selects another session key identification number from the stored security scheme table. However, it should be noted that the number of times the process returns to step 808 from step 820 because the reconstructed password does not match the stored password associated with the client device is predefined by the particular set of security parameters selected. For example, if the reconstructed password does not match the stored password three times for a particular session, then the authentication server device may, for example, notify a system administrator and terminate the session.

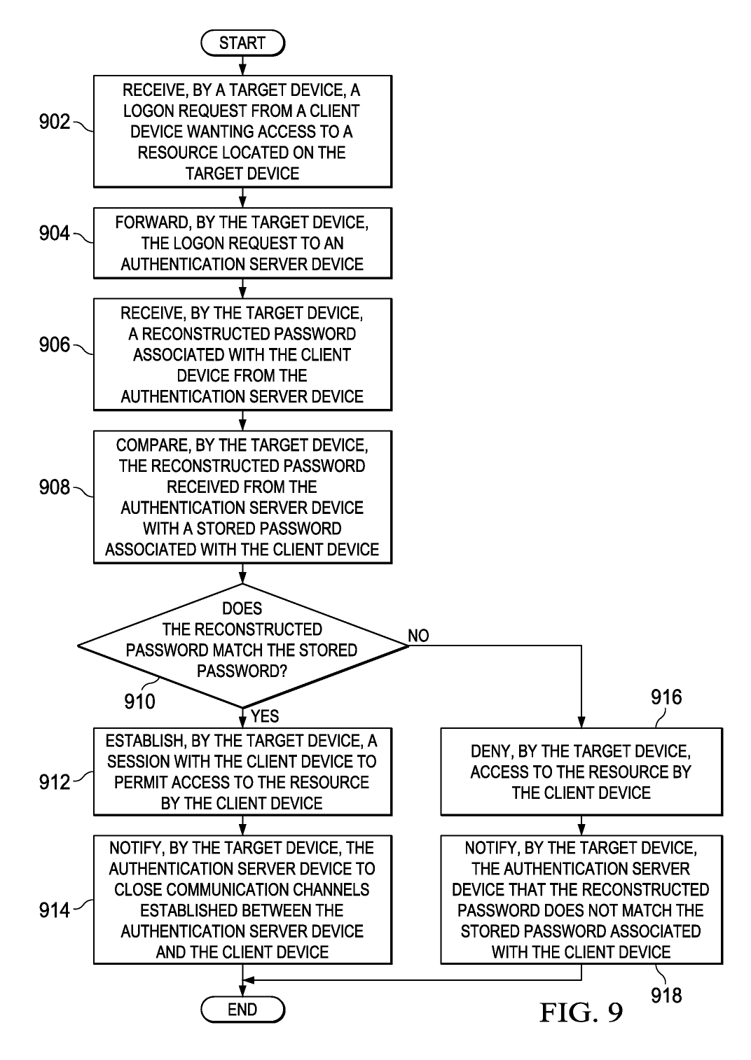

With reference now to FIG. 9, a flowchart illustrating a process for a target device is shown in accordance with an illustrative embodiment. The process shown in FIG. 9 may be implemented in a target device, such as, for example, target device 306 in FIG. 3.

The process starts when the target device receives a logon request from a client device wanting access to a resource located on the target device (step 902). The client device may, for example, be client device 302 in FIG. 3. The resource may, for example, be protected resource 318 in FIG. 3 and may be an application, such as an accounting application, or confidential data, such as a bank statement associated with a user of the client device.

After receiving the logon request from the client device in step 902, the target device forwards the logon request to an authentication server device (step 904). The authentication server device may, for example, be authentication server device 304 in FIG. 3. Subsequently, the target device receives a reconstructed password associated with the client device from the authentication server device (step 906). The reconstructed password may, for example, be reconstructed password 314 in FIG. 3.

Then, the target device compares the reconstructed password received from the authentication server device with a stored password associated with the client device (step 908). The stored password may, for example, be stored password 316 in FIG. 3. Afterward, the target device makes a determination as to whether the reconstructed password matches the stored password (step 910). If the reconstructed password does match the stored password, yes output of step 910, then the target device establishes a session with the client device to permit access to the resource by the client device (step 912). Subsequently, the target device notifies the authentication server device to close the communication channels established between the authentication server device and the client device (step 914) and the process terminates thereafter. If the reconstructed password does not match the stored password, no output of step 910, then the target device denies access to the resource by the client device (step 916). Afterward, the target device notifies the authentication server device that the reconstructed password does not match the stored password associated with the client device (step 918) and the process terminates thereafter.

Thus, illustrative embodiments of the present invention provide a computer implemented method, computer system, and computer program product for authenticating a network security password that has been segmented into a predetermined number of password segments and sent over a predetermined number of communication channels in parallel at a same time. As a result, not one communication channel needs to be intercepted by an unauthorized user, but a predetermined variable number of parallel communication channels need to be intercepted all at the same time. Also, even if all the password segments associated with a password are intercepted, the correct order of the password segments to reconstruct the original password is only known by the sending client device and the receiving authentication server device. Further, even if the authentication server can be “emulated,” the original password still cannot be reconstructed by the emulated authentication server because the security scheme to reconstruct the password is not known by the emulated authentication server.

Moreover, it may be more difficult to decrypt a password that is mixed up after encryption. In addition, illustrative embodiments only require additional data to be transmitted to the authentication server device and not to the target device. Further, the network security complexity of illustrative embodiments is scalable and is predetermined based on the level of security agreed upon by the users of the password authentication system.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer implemented method for authenticating a password, the computer implemented method comprising:
receiving, by an authentication server device, a plurality of password segments associated with a password from a client device over a plurality of communication channels;
reconstructing, by the authentication server device, the password from the plurality of password segments based on a particular set of parameters identified by a selected session key identification number to form a reconstructed password; and
sending, by the authentication server device, the reconstructed password to a target device for comparison with a stored password associated with the client device.

2. The computer implemented method of claim 1 further comprising:
receiving, by the authentication server device, a forwarded logon request from the target device that is associated with the client device wanting access to a resource located on the target device;
determining, by the authentication server device, a user identification associated with the client device based on the forwarded logon request;
retrieving, by the authentication server device, a stored security scheme table associated with the user identification;
selecting, by the authentication server device, a session key identification number from the stored security scheme table to form a selected session key identification number; and
sending, by the authentication server device, the selected session key identification number to the client device.

3. The computer implemented method of claim 1 further comprising:
receiving, by the authentication server device, a notification from the target device that the reconstructed password matches the stored password associated with the client device; and
responsive to receiving the notification from the target device that the reconstructed password matches the stored password associated with the client device, closing, by the authentication server device, the plurality of communication channels established with the client device.

4. The computer implemented method of claim 1 wherein each password segment in the plurality of password segments is received from the client device one password segment per one communication channel in the plurality of communication channels.

5. The computer implemented method of claim 1 wherein each password segment in the plurality of password segments is sent to the authentication server device in parallel at a same time over the plurality of communication channels.

6. The computer implemented method of claim 1 wherein the plurality of password segments is received from the client device in an out-of-order sequence.

7. The computer implemented method of claim 1 wherein password segments in the plurality of password segments include dummy password values interspersed with valid password values, and wherein positions of the valid password values within the password segments is defined by the particular set of parameters identified by the selected session key identification number.

8. The computer implemented method of claim 1 wherein the plurality of password segments is encrypted.

9. The computer implemented method of claim 1 wherein the plurality of communication channels is a predetermined number of communication channels defined by the particular set of parameters identified by the selected session key identification number.

10. The computer implemented method of claim 9 wherein the predetermined number of communication channels defined by the particular set of parameters identified by the selected session key identification number includes a predetermined number of dummy communication channels that transmit dummy password segments.

11. The computer implemented method of claim 1 wherein the plurality of password segments is a predetermined number of password segments defined by the particular set of parameters identified by the selected session key identification number.

12. The computer implemented method of claim 2 wherein the stored security scheme table is one of a plurality of stored security scheme tables stored on the authentication server device, each of the stored security scheme tables in the plurality of stored security scheme tables is associated with a different user identification.

13. The computer implemented method of claim 1 wherein the authentication server device performs intermittent password authentication steps after initial authentication of the password by the target device a predetermined time interval basis defined by the particular set of parameters identified by the selected session key identification number.

14. A data processing system for authenticating a password, the data processing system comprising:
a bus system;
a storage device connected to bus system, wherein the storage device stores a set of instructions; and
a processing unit connected to the bus system, wherein the processing unit executes the set of instructions to receive a plurality of password segments associated with a password from a client device over a plurality of communication channels; reconstruct the password from the plurality of password segments based on a particular set of parameters identified by a selected session key identification number to form a reconstructed password; and send the reconstructed password to a target device for comparison with a stored password associated with the client device.

15. A data processing system of claim 14 wherein the processing unit executes a further set of instructions to receive a notification from the target device that the reconstructed password matches the stored password associated with the client device; and close the plurality of communication channels established with the client device in response to receiving the notification from the target device that the reconstructed password matches the stored password associated with the client device.

16. A computer program product stored on a computer readable storage medium having computer usable program code embodied thereon that is executable by a computer for authenticating a password, the computer program product comprising:
computer usable program code for receiving a plurality of password segments associated with a password from a client device over a plurality of communication channels;
computer usable program code for reconstructing the password from the plurality of password segments based on a particular set of parameters identified by a selected session key identification number to form a reconstructed password; and
computer usable program code for sending the reconstructed password to a target device for comparison with a stored password associated with the client device.

17. The computer program product of claim 16 further comprising:
computer usable program code for receiving a forwarded logon request from the target device that is associated with the client device wanting access to a resource located on the target device;
computer usable program code for determining a user identification associated with the client device based on the forwarded logon request;
computer usable program code for retrieving a stored security scheme table associated with the user identification;
computer usable program code for selecting a session key identification number from the stored security scheme table to form a selected session key identification number; and
computer usable program code for sending the selected session key identification number to the client device.

18. The computer program product of claim 16 further comprising:
computer usable program code for receiving a notification from the target device that the reconstructed password matches the stored password associated with the client device; and
computer usable program code for closing the plurality of communication channels established with the client device in response to receiving the notification from the target device that the reconstructed password matches the stored password associated with the client device.

19. The computer program product of claim 16 wherein each password segment in the plurality of password segments is received from the client device one password segment per one communication channel in the plurality of communication channels.

20. The computer program product of claim 16 wherein each password segment in the plurality of password segments is sent to an authentication server device in parallel at a same time over the plurality of communication channels.
